(19) United States
(12) Patent Application Publication
(10) Pub. No.: US 2025/0384729 A1
(43) Pub. Date: Dec. 18, 2025

(54) Blockchain-Based Encrypted Voting System and Method of Use

(71) Applicant: Adam Denoto, Brook Park, OH (US)

(72) Inventor: Adam Denoto, Brook Park, OH (US)

(21) Appl. No.: 19/013,432

(22) Filed: Jan. 8, 2025

Related U.S. Application Data
(60) Provisional application No. 63/659,359, filed on Jun. 13, 2024.

(51) Int. Cl. G07C 13/00; H04L 9/00; H04L 9/32

(52) U.S. Cl. CPC G07C 13/00; H04L 9/3231; H04L 9/50

(57) ABSTRACT

The present invention is a secure blockchain-based voting system. The system includes a mobile application that enables voters to register, authenticate via biometrics and another factor (i.e., two-factor verification), and cast votes using a color-coded ballot interface. Each vote is encrypted, digitally signed with the voter's private key, and broadcast to a blockchain network of nodes for validation and secure storage. Blockchain nodes implement smart contracts to automate processes such as vote recording and duplicate vote prevention. Validated vote transactions are grouped into blocks, which are then replicated across all nodes to maintain an immutable, synchronized voting ledger. An audit trail, including timestamps and unique transaction IDs, is also generated.

### CROSS-REFERENCE TO RELATED APPLICATION

The present application claims priority to, and the benefit of, U.S. Provisional Application No. 63/659,359 which was filed on Jun. 13, 2024, and is incorporated herein by reference in its entirety.

### FIELD OF THE INVENTION

The present invention generally relates to secure digital voting systems. More specifically, the invention relates to an encrypted blockchain-based voting ledger designed to enhance the integrity and accessibility of the voting process by leveraging end-to-end encryption, biometric authentication, and blockchain technology. The system comprises a mobile application that facilitates remote voting with a secure, user-friendly interface, enabling voters to select from color-coded ballot options and confirm their votes. The system includes a network of blockchain nodes that maintain an immutable, distributed ledger of votes, wherein each node validates transactions to prevent tampering or double voting. Accordingly, the present disclosure makes specific reference thereto. Nonetheless, it is to be appreciated that aspects of the present invention are also equally applicable to other like applications, devices, and methods of manufacture.

### BACKGROUND

By way of background, voting is a fundamental democratic process that enables citizens to express their preferences and participate in decision-making at local, state, and federal levels. Traditional voting systems, include paper ballots and electronic voting machines, however, these often lack sufficient safeguards against tampering and manipulation. Traditional voting systems are vulnerable to various forms of interference, including unauthorized ballot duplication and data breaches. The fear of unethical practices can deter voters, weaken democratic participation, and erode public trust in government institutions. Key issues, such as double ballot counting, unauthorized access to ballots, and potential voter fraud, can compromise the accuracy and trustworthiness of election outcomes.

In addition to security concerns, the accessibility of polling stations presents another significant barrier. Traditionally, voters are required to physically visit polling booths to cast their ballots, which can be challenging for elderly individuals, individuals with mobility issues, and those in remote locations. This requirement limits access for many eligible voters, who may be unable to participate fully due to physical constraints or logistical challenges. Individuals desire a voting system that enables voters to securely cast ballots from any location.

Therefore, there exists a long-felt need in the art for a secure, accessible, and transparent voting system that addresses both security and accessibility issues in elections. There is a need for a voting solution that prevents unauthorized access, double voting, and tampering. Additionally, there is a need for a voting system that enables individuals to vote remotely, reducing barriers for elderly and mobility-challenged voters who may struggle to reach polling stations. Moreover, there is a need for a system that ensures each vote is counted accurately and provides verifiable audit trails that election officials and auditors can access without compromising voter privacy. Further, there is a need for a system that records votes in an immutable format, making it resistant to manipulation and enhancing election transparency. Finally, there is a need for a user-friendly voting application that is secure, intuitive, and accessible to a broad range of voters and which maintains integrity of the election process.

The subject matter disclosed and claimed herein, in one embodiment, comprises an Encrypted Voting Blockchain Ledger system specifically designed to address the limitations of traditional voting systems. The system utilizes a mobile application interface that enables remote voting with secure, end-to-end encryption and biometric authentication for voter verification. The application includes a color-coded ballot interface that simplifies the voting process, enabling voters to select and confirm their choices easily. The voting system features a blockchain network composed of multiple nodes, each holding a full, immutable copy of the voting ledger, which ensures transparency and security through consensus validation. An audit module generates a complete, traceable audit trail for every vote transaction, including timestamps and unique transaction IDs.

In this manner, the Encrypted Voting Blockchain Ledger system of the present invention accomplishes all of the foregoing objectives by providing a secure, accessible, and transparent solution for digital voting. The mobile application is equipped with biometric verification and a two-factor authentication process, and therefore, prevents unauthorized access and provides authenticity of each vote. The color-coded ballot and user-friendly interface improve accessibility for all users, including elderly or mobility-challenged voters, enabling them to participate remotely in elections. By storing votes on an immutable blockchain ledger, the system ensures that each vote is securely recorded and protected against tampering.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a voting system leveraging blockchain technology and encryption for secure digital voting. The voting system comprises a mobile application configured to present a user interface displaying ballot options, a plurality of blockchain nodes is configured to form a blockchain network, each blockchain node is adapted to hold a copy of a voting ledger and validate vote transactions, wherein each blockchain node implements smart contracts to automate voting-related processes, including recording votes and preventing double-voting. A plurality of encryption modules are integrated with the mobile application and the blockchain network, wherein each encryption module is configured to provide dual-layer encryption by encrypting vote data initially within the mobile application and further encrypting the data once recorded on the blockchain nodes. A registered voters database for storing voter information including biometric templates, unique identifiers, and contact details. An audit module is configured to generate an audit trail for each voting transaction, the audit trail includes a timestamp and unique transaction ID. A real-time reporting module is adapted to provide voting data updates and track performance, security, and integrity of the blockchain nodes and the mobile application.

In another aspect, a method for secure voting using a blockchain-based system is disclosed. The method comprises registering a voter on a mobile application by collecting personal information, capturing a biometric identifier, and storing the information in a registered voters database for verification, authenticating the voter through biometric verification on the mobile application and providing secondary verification using a two-factor authentication method, presenting a ballot on the mobile application interface, wherein the ballot includes color-coded options representing different candidates or parties, and enabling the voter to select an option and confirm their choice, encrypting the selected vote within the mobile application, broadcasting the encrypted and signed vote to a plurality of blockchain nodes, and validating the vote transaction at the blockchain nodes and recording it on the blockchain ledger.

In another embodiment, a method for recording and auditing votes in a blockchain voting system is disclosed. The method includes the steps of receiving an encrypted vote transaction from a mobile application at a plurality of blockchain nodes in a blockchain network, validating the received vote transaction at each blockchain node by checking the digital signature, verifying voter identity, and confirming the absence of duplicate votes, grouping validated vote transactions into blocks, replicating the block across all blockchain nodes, generating an audit trail for each vote transaction, and providing approved external auditors with read-only access to the blockchain data to verify voting results.

In yet another aspect, a non-transitory computer-readable medium storing instructions that, when executed by one or more processors, cause the system to perform a secure voting method using a blockchain-based network is disclosed. The method comprises displaying a voter registration interface on a mobile application, capturing voter information including biometric data, and storing the data in a registered voters database, authenticating a voter by verifying biometric data and providing a two-factor authentication method to confirm voter identity, displaying a ballot interface with color-coded voting options, enabling the voter to select and confirm a choice, and encrypting the vote data using end-to-end encryption, digitally signing the encrypted vote with the voter's private key and broadcasting the signed vote to a plurality of blockchain nodes, and recording the validated vote on the blockchain ledger.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of encrypted voting blockchain ledger system of the present invention in accordance with the disclosed structure;

FIG. 2 illustrates a perspective view showing a user using biometric authentication on the mobile application for registration to vote in accordance with the disclosed architecture;

FIG. 3 illustrates a user interface displayed by the mobile application showing the ballot for voting in accordance with one embodiment of the present invention;

FIG. 4 illustrates an exemplary user interface displayed by the mobile application showing the application tallying a vote for the casted party in accordance with one embodiment of the present invention; and

FIG. 5 illustrates a flow chart depicting a process of recording a vote as a secure transaction on the blockchain network in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a secure, accessible, and transparent voting system that addresses both security and accessibility issues in elections. There is a need for a voting solution that prevents unauthorized access, double voting, and tampering. Additionally, there is a need for a voting system that enables individuals to vote remotely, reducing barriers for elderly and mobility-challenged voters who may struggle to reach polling stations. Moreover, there is a need for a system that ensures each vote is counted accurately and provides verifiable audit trails that election officials and auditors can access without compromising voter privacy. Further, there is a need for a system that records votes in an immutable format, making it resistant to manipulation and enhancing election transparency. Finally, there is a need for a user-friendly voting application that is secure, intuitive, and accessible to a broad range of voters and which maintains integrity of the election process.

The present invention, in one exemplary embodiment, is a method for recording and auditing votes in a blockchain voting system. The method includes the steps of receiving an encrypted vote transaction from a mobile application at a plurality of blockchain nodes in a blockchain network, validating the received vote transaction at each blockchain node by checking the digital signature, verifying voter identity, and confirming the absence of duplicate votes, grouping validated vote transactions into blocks, replicating the block across all blockchain nodes, generating an audit trail for each vote transaction, and providing approved external auditors with read-only access to the blockchain data to verify voting results.

Reference will now be made in detail to the present preferred embodiments of the invention, examples of which are illustrated in the accompanying drawings. Wherever possible, the same reference numerals are used in the drawings and the description to refer to the same or like parts.

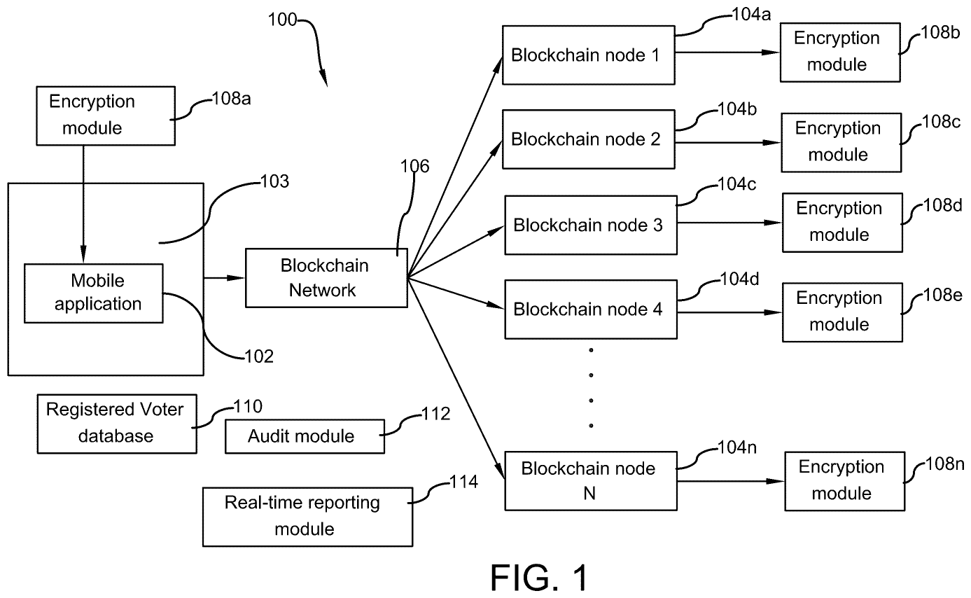

Referring initially to the drawings, FIG. 1 illustrates a schematic view of encrypted voting blockchain ledger system of the present invention in accordance with the disclosed structure. The encrypted voting blockchain ledger system 100 of the present invention is designed as a digital voting solution leveraging blockchain and encryption technologies to secure the voting process. The system 100 is configured to enhance transparency and improve voter confidence. More specifically, the system 100 includes a mobile application 102 installed in an electronic computing device 103 and provides a clean, accessible, and intuitive layout for voters, including clear instructions, ballot options, and color-coded voting options for easy selection. The mobile application 102 integrates facial recognition or other biometric technology to verify voter identity.

A plurality of blockchain nodes 104a-n embodied preferably as computers or servers form the blockchain network 106. Each node of the plurality of blockchain nodes 104a-n holds a copy of the entire voting ledger and validates vote transactions, thereby ensuring consensus and security. Each node may implement smart contracts to automate voting-related processes such as recording a vote and preventing double voting.

A plurality of encryption modules 108a-n are included in the system and are adapted to encrypt the vote data cast using the mobile application 102. The encryption modules 108a-n provide a dual layer encryption with an initial encryption in the mobile application 102 and a second layer of encryption to data once the data is recorded in the blockchain nodes 104a-n. A registered voters database 110 stores voters' information and is used for verifying registered voters. Information such as biometric templates, unique identifiers, and contact details is stored in the database 110 for voter authentication.

An audit module 112 is included in the secure voting blockchain ledger system 100 and automatically generates an audit trail for each voting transaction, including timestamps and unique transaction IDs. The audit trail is used for traceability and review of the voting data by regulatory authorities. The audit module 112 also enables approved external auditors to access the blockchain data in a transparent, read-only format to verify voting results without compromising privacy.

A real-time reporting module 114 is adapted to provide real-time updates on voting numbers, maintaining transparency without revealing individual voter data. Further, the reporting module 114 tracks the performance, security status, and integrity of the blockchain nodes 104a-n and the application 102, monitoring for unusual activity and system performance issues.

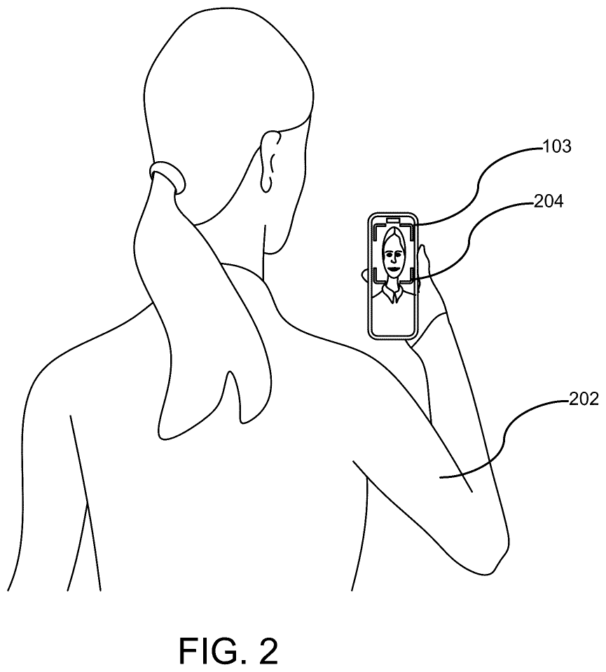

FIG. 2 illustrates a perspective view showing a user using biometric authentication on the mobile application for registration to vote in accordance with the disclosed architecture. A user 202 initially for voting using the secure voting blockchain ledger system 100 registers on the system 100 and creates an account, entering personal information (e.g., name, ID number) along with a biometric factor such as a face image. The system 100 verifies identity of the voter through official databases and using a secondary identification check, such as facial recognition 204 with a government-issued ID. Once registered, the voter 202 scan their faces or other biometrics for authentication during voting and on successful biometric authentication, an OTP or a prompt to enter a PIN is displayed for two-factor authentication of the voter 202.

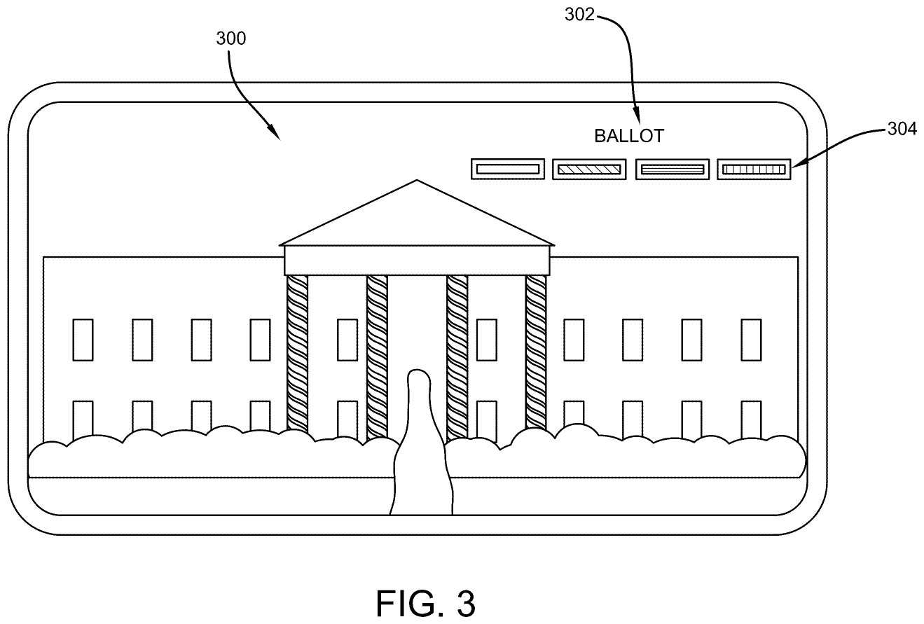

FIG. 3 illustrates a user interface displayed by the mobile application showing the ballot for voting in accordance with one embodiment of the present invention. As illustrated, the interface 300 displays the voting ballot 302, which includes a plurality of color-coded options 304 for easy identification of different parties or voting candidates. Each color-coded option uniquely identifies a party or candidate, and a voter can select an option for casting vote. The interface 300 may display a prompt for vote confirmation to prevent accidental votes. The selected vote is encrypted in the application 102 using end-to-end encryption, ensuring that that the vote remains private. Each registered voter has a private key and the voter's private key signs the vote, thereby creating a unique, tamper-proof signature tied to their identity without revealing personal information.

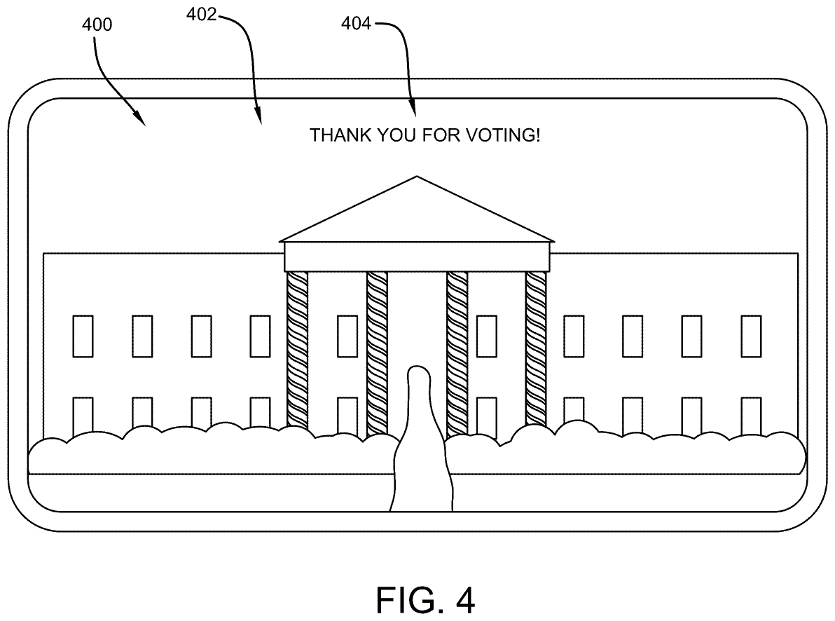

FIG. 4 illustrates an exemplary user interface displayed by the mobile application showing the application tallying a vote for the casted party in accordance with one embodiment of the present invention. As illustrated, when the voter 202 chooses one of the options 304 (which may be encoded in a specific color corresponding to a party), the interface 400 is transformed into the color 402 of the option along with a confirmation message 404 such as “THANK YOU FOR VOTING” indicating successful vote and tallying of the vote by the system 100. Error messages may also be displayed if there is an issue, such as network connectivity problems or failed validation attempts.

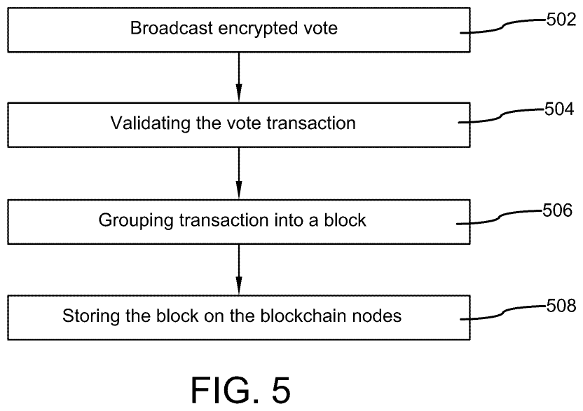

FIG. 5 illustrates a flow chart depicting a process of recording a vote as a secure transaction on the blockchain network in accordance with one embodiment of the present invention. Initially, the encrypted vote from the application 102 is broadcasted to all blockchain nodes 104a-n (Step 502). Then, the nodes validate the vote transaction and may check for one or more of voter's signature authentication and absence of duplicate votes (Step 504). Thereafter, the validated transactions are grouped into a block with a unique hash and are added to one of the blockchain nodes (Step 506). Once a block is added, the block is distributed to all nodes 104a-n, ensuring each node has an identical and most recent copy of the voting record (Step 508).

The blockchain-based encrypted voting system 100 is preferably deployed on a private blockchain, which restricts participation to authorized nodes such as election authorities, however, can also be deployed on a public blockchain, which enables any party to validate transactions. Every vote transaction is assigned a unique identifier and timestamp, enabling a full audit trail without compromising voter privacy.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “blockchain-based encrypted voting system”, “secure voting blockchain ledger system”, “encrypted voting blockchain ledger system”, and “system” are interchangeable and refer to the blockchain-based encrypted voting system 100 of the present invention.

Notwithstanding the forgoing, the blockchain-based encrypted voting system 100 of the present invention can be of any suitable size and configuration as is known in the art without affecting the overall concept of the invention, provided that it accomplishes the above stated objectives. One of ordinary skill in the art will appreciate that the blockchain-based encrypted voting system 100 as shown in the FIGS. are for illustrative purposes only, and that many other configurations of the blockchain-based encrypted voting system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An encrypted voting blockchain ledger system comprising:
a digital voting blockchain network having an encryption to secure a voting process;
a mobile application;
an electronic computing device;
a biometric analyzer to verify voter identity;
a plurality of blockchain nodes including a plurality of servers forming said digital voting blockchain network;
a plurality of encryption modules; and
a registered voters database;
wherein said biometric analyzer includes facial recognition;
wherein each node of said plurality of blockchain nodes having a copy of a voting ledger;
wherein each node of said plurality of blockchain nodes validates each vote transaction; and
further wherein said plurality of encryption modules adapted to encrypt the vote data cast using said mobile application.

2. The encrypted voting blockchain ledger system of claim 1, wherein said plurality of encryption modules provide a dual layer encryption including a first layer of encryption in said mobile application and a second layer of encryption to data once the data is recorded in said plurality of blockchain nodes.

3. The encrypted voting blockchain ledger system of claim 2, wherein said registered voters database having a voters' information.

4. The encrypted voting blockchain ledger system of claim 3, wherein said voters' information includes verifying registered voters with a unique transaction identification selected from the group consisting of a biometric template, a unique identifier, and a contact detail stored in said registered voters database for voter authentication.

5. The encrypted voting blockchain ledger system of claim 4 further comprising an audit module, wherein said audit module having a voting blockchain ledger.

6. The encrypted voting blockchain ledger system of claim 5, wherein said voting blockchain ledger generates an audit trail for each voting transaction.

7. The encrypted voting blockchain ledger system of claim 6, wherein said voting transaction includes a timestamp and said unique transaction identification.

8. The encrypted voting blockchain ledger system of claim 7, wherein said audit trail is a read-only format.

9. The encrypted voting blockchain ledger system of claim 8 further comprising a real-time reporting module, wherein said real-time reporting module provides real-time updates on voting numbers.

10. The encrypted voting blockchain ledger system of claim 9, wherein said real-time reporting module tracking indicators selected from the group consisting of a security status, an integrity of said blockchain nodes, a monitor for unusual activity, and a system performance indicator.

11. A method of encrypted voting, the method comprising the steps of:
providing a blockchain ledger system having a digital voting blockchain network having an encryption to secure a voting process, a mobile application, an electronic computing device, a biometric analyzer to verify voter identity, a plurality of blockchain nodes including a plurality of servers forming said digital voting blockchain network, a plurality of encryption modules, and a registered voters database, wherein said biometric analyzer includes facial recognition, further wherein each node of said plurality of blockchain nodes having a copy of a voting ledger;
validating each vote transaction with each node of said plurality of blockchain nodes; and
encrypting the vote data cast using said mobile application with said plurality of encryption modules.

12. The method of encrypted voting of claim 11, wherein said plurality of encryption modules provide a dual layer encryption including a first layer of encryption in said mobile application and a second layer of encryption to data once the data is recorded in said plurality of blockchain nodes.

13. The method of encrypted voting claim 12, wherein said registered voters database having a voters' information.

14. The method of encrypted voting of claim 13, wherein said voters' information includes verifying registered voters with a unique transaction identification selected from the group consisting of a biometric template, a unique identifier, and a contact detail stored in said registered voters database for voter authentication.

15. The method of encrypted voting of claim 14 further comprising a step of providing an audit module, wherein said audit module having a voting blockchain ledger.

16. The method of encrypted voting of claim 15, wherein said voting blockchain ledger generates an audit trail for each voting transaction.

17. The method of encrypted voting of claim 16, wherein said voting transaction includes a timestamp and said unique transaction identification.

18. The method of encrypted voting of claim 17, wherein said audit trail is a read-only format.

19. The method of encrypted voting of claim 18 further comprising the step of providing a real-time reporting module, wherein said real-time reporting module provides real-time updates on voting numbers.

20. A method of encrypted voting, the method comprising the steps of:
providing a blockchain ledger system having a digital voting blockchain network having an encryption to secure a voting process, a mobile application, an electronic computing device, a biometric analyzer to verify voter identity, a plurality of blockchain nodes including a plurality of servers forming said digital voting blockchain network, a plurality of encryption modules, a registered voters database, and an audit module, wherein said biometric analyzer includes facial recognition, further wherein each node of said plurality of blockchain nodes having a copy of a voting ledger;
validating each vote transaction with each node of said plurality of blockchain nodes; and
encrypting the vote data cast using said mobile application with said plurality of encryption modules;
providing a dual layer encryption with said plurality of encryption modules including a first layer of encryption in said mobile application and a second layer of encryption to data once the data is recorded in said plurality of blockchain nodes; and
providing a voting blockchain ledger with said audit module, wherein said voting blockchain ledger generates an audit trail for each voting transaction.
